(19) United States
(12) Patent Application Publication
(10) Pub. No.: US 2026/0307895 A1
(43) Pub. Date: Oct. 8, 2026

(54) YardHaul

(71) Applicant: Austin Andersen, Overland Park, KS (US)

(72) Inventor: Austin Andersen, Overland Park, KS (US)

(21) Appl. No.: 19/169,225

(22) Filed: Apr. 3, 2025

(51) Int. Cl. B65F 1/00; B65F 1/14

(52) U.S. Cl. CPC B65F 1/002; B65F 1/1468; B65F 2001/1489

(57) ABSTRACT

A reusable protective wrap designed to enclose one or more yard waste bags for the purpose of shielding them from ground moisture and environmental exposure. The wrap includes elastic closures at both top and bottom, a vertical zippered access panel, reinforced carry handles, and optional wheel attachments for improved portability. YardHaul is constructed of water-resistant material and may be used with one to six standard-sized kraft paper lawn bags.

### FIELD OF THE INVENTION

The present invention relates to waste management accessories, and more particularly to a reusable, moisture-resistant wrap designed to hold and protect one or more yard waste bags.

### BACKGROUND OF THE INVENTION

Standard paper yard waste bags often fail under wet or muddy conditions. When placed on damp lawns or curbs, these bags absorb moisture, tear, and collapse, making cleanup more difficult. Existing solutions such as rigid bins or tarps lack the flexibility and portability needed for easy use and storage.

### SUMMARY OF THE INVENTION

The invention addresses these problems with a reusable wrap that secures around yard waste bags using elastic closures and provides easy access through a vertical zipper flap. The product is designed to be expandable, allowing it to hold between one and six bags. Reinforced handles allow for lifting or dragging, and optional wheels simplify transport.

### DESCRIPTION OF THE PREFERRED EMBODIMENT

The YardHaul wrap is constructed of flexible, waterproof material such as vinyl-coated polyester. Elastic drawstrings encircle both the top and bottom hems to secure the bags inside. A vertical zipper provides front access for loading or unloading. Reinforced nylon webbing handles are sewn onto opposing sides. In higher-capacity models, a set of wheels may be affixed to one lower corner to facilitate rolling. When not in use, the wrap folds flat for storage.

1. A reusable wrap for yard waste bags comprising:
a flexible, water-resistant main body;
an elastic closure at a top edge and a bottom edge; and
at least one vertical zipper configured to open a front-facing access flap.

2. The reusable wrap of claim 1, further comprising a set of reinforced handles stitched to opposing sides of the wrap.

3. The reusable wrap of claim 1, wherein the wrap includes an internal volume sized to contain up to six yard waste bags arranged in a 3-by-2 configuration.

4. The reusable wrap of claim 1, further comprising at least one wheel affixed to a bottom corner of the wrap for tilting and rolling.

5. The reusable wrap of claim 1, wherein the vertical zipper runs substantially the entire height of the wrap from top to bottom edge.

6. The reusable wrap of claim 1, wherein the wrap is foldable and washable for seasonal reuse.
